(19) United States
(12) Patent Application Publication
(10) Pub. No.: US 2008/0028760 A1
(43) Pub. Date: Feb. 7, 2008

(54) Philippians 419 engine - power generation

(76) Inventors: Donald Ross Bedwell, Columbia City, IN (US); Sharyl Anne Bedwell, Columbia City, IN (US)

Correspondence Address: Donald Ross Bedwell, 386 E 400 N, Columbia City, IN, 46725, US

(21) Appl. No.: 11/504,294

(22) Filed: Aug. 15, 2006

(51) Int. Cl. F03B 17/02; F03B 13/18

(52) U.S. Cl. 60/504; 60/495

(57) ABSTRACT

The Philippians 419 Engine is a machine that produces kinetic energy by using the phenomenon of buoyancy and gravity. No fuel is consumed and no waste elements are produced thus, an inexpensive form of power generation is produced and the Earth can be left alone to heal. The Christian Bible in Philippians 4:19 states that GOD will meet all of our needs. This engine is one way HE is doing just that.

### RELATED APPLICATIONS

After searching formal records, I have found no other mechanical system containing the operational process and mechanical devices like the Philippians 419 Engine thus labeling it unique and inclusive.

### FIELD OF THE INVENTION

The present invention relates to . . . and, more particularly, to . . . the ability of exposing a sequence of floats into a body of liquid by entering into the body of liquid from below the bottom depth of the liquid and allowing them to rise to the surface. The sequence of floats are captured together in a closed loop chain thus allowing continuous rotational movement about an adjoining axle producing kinetic rotational energy.

### BACKGROUND OF THE INVENTION

Today's world requires much energy. Everyday she hungrily drinks countless gallons of crude oil and chews up tons of coal and other minerals trying to satisfy her hunger. As the Earth exists, each day her appetite grows. The population of nations continually rise and environments change to support this growth. Housing, manufacturing, recreation, transportation, personal goods, food, water, along with many other items are all in this chow line eager to get their fill of energy. Man is determined to raise his standard of living and creature comforts are often his goal. Man's need for more and more energy will only increase as his goals for improvement of his standard of living are pursued and accomplished.

Much of the required energy is produced by refining crude oil. At one point of time, crude oil was in abundance and located close. Now, millions of dollars are spent hourly drilling, pumping and refining crude petroleum. Locations for drilling are often many miles from required users, forcing transportation. Sometimes crude oil is found in locations where environmental concerns prohibit drilling. Those nations where crude oil is abundant often establish selling prices for their oil at levels considered by many as outrageous. To obtain energy, men have lied and cheated. Wars that have killed many people can be attributed to the seeking energy.

High energy costs drive many people to live without. Summer heat takes its toll because cooling is expensive. Winter cold takes its toll because heating is expensive. The world's poor are being trodden upon because to give them energy is expensive.

Supplies of many of these energy resources are dwindling. Studies show that the requirement for energy is growing at a faster rate than the Earth can replenish them.

An all out attack is underway to supply energy by every nation on Earth. We are drilling and pumping crude oil at levels never imagined 20 years ago. The mining of coal throughout the world is at an all time high frequency. Enormous dams are being constructed throughout the world in order to generate much needed energy. Man is re-visiting wind as a source for power again and even the atom is being wrenched for its “power gold”. Everywhere one turns evidence of “mining” for energy is taking place. We burn and smash, we refine and gather yet the target of accomplishment is moving further and further away.

All efforts to obtain energy bring along with them costs. Costs to mine, to pump, to smash, to cut, to burn, to refine, to store, to distribute and to even use energy are rising faster than incomes. This differential of moneys is eliminating many people from using what energy we do have.

It is therefore an object of the invention to . . . provide to the world an alternative energy source.

It is another object of the invention to . . . provide to the world a low cost energy source.

It is another object of the invention to . . . provide to the world an environmental friendly energy source.

It is another object of the invention to . . . provide to the world a non-complicated energy source.

It is another object of the invention to . . . provide to the world a low maintenance energy source.

It is another object of the invention to . . . provide to the world an easily “scaled for the requirement” energy source.

It is another object of the invention to . . . provide to the world a “human safe” energy source.

It is another object of the invention to . . . provide to the world an energy source that is designed for individual use and thus ridding the world of extensive, expensive and wide range outage possibility grids and systems.

It is another object of the invention to . . . improve the living standards of the human race.

It is another object of the invention to . . . provide to the world an energy source that can be hidden for beauty.

### SUMMARY OF THE INVENTION

The Philippians 419 Engine is a machine that produces kinetic energy by using the phenomenon of buoyancy and gravity. A closed loop of floats enter a body of water from underneath the bottom side of the water chamber and are powered up to the top surface by buoyancy. Since the floats are bound together end to end, and are securely attached to a central necklace cable, every float is closely followed by another causing a continuous process of floats rising to the surface. After the floats exit the body of the water from the top surface, their path is 180 degrees around a tension pulley and proceed downward, outside the water chamber. The floats are then driven down to a bottom cogged driven pulley and applies pressure against the cogs by gravity acting upon the downward floats and the power produced by buoyancy acting upon the upward floats on the opposite side of the necklace float chain. The downward floats circle this bottom pulley 180 degrees and re-enter the water chamber to become “buoyancy floats” once again. This cyclic, continuous rising and falling of floats are powered only by God's Earth buoyancy and gradational powers. No fuel is consumed and no waste elements are produced thus, an inexpensive form of power generation is manufactured and the Earth can be left alone to heal.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of a drawing showing the four main sub-assemblies of the philippians 419 engine;

FIG. 2 is a front perspective view of a sub-assembly #1, frame assembly, and its components;

FIG. 3 is a front perspective view of a sub-assembly #2, drive train assembly and its components;

FIG. 4 is a front perspective view of a sub-assembly #3, float chain assembly and its components;

FIG. 5 is a front perspective view of a sub-assembly #4, float chamber assembly and its components;

FIG. 6 is a front perspective view of a drawing showing power calculation examples;

FIG. 7 is a front perspective view of a drawing showing possible usages and installation examples—multiple unit configuration;

FIG. 8 is a front perspective view of a drawing showing possible usages and installation examples—above ground; and

FIG. 9 is a front perspective view of a drawing showing possible usages and installation examples—under liquid or underground.

For purposes of clarity and brevity, like elements and components will bear the same designations and numbering throughout the Figures.

### DESCRIPTION OF THE PREFERRED EMBODIMENT

The Philippians 419 Engine is a machine that takes off where Archimedes left off. The world has long used buoyancy by starting at the top surface of a body of liquid. The Philippians 419 Engine uses buoyancy by reversing the traditional thought path and it starts buoyancy by entering a body of liquid from the bottom surface. The very moment that a physical body, lighter than water in volume, exposes its lower surface, in part or in whole to a liquid, the pressure of the liquid produces an up-ward force upon that body. This is the fuel of the Philippians 419 Engine.

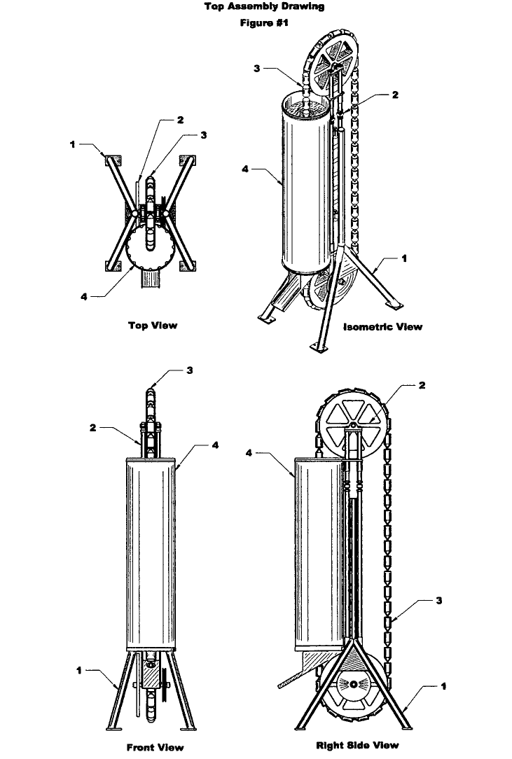

FIG. 1 is a detail view of a drawing showing the four main sub-assemblies of the Philippians 419 engine. It is this drawing that gives the overall view of the engine. The sub-assembly components of this engine are the frame sub-assembly 1, the drive train sub-assembly 2 (element #2), the float chain sub-assembly 3 and the float chamber sub-assembly 4. These are the basic components needed to build a Philippians 419 Engine. Actual size of these sub-assembly's will be determined by the builder when consideration for expected power output enters the equation.

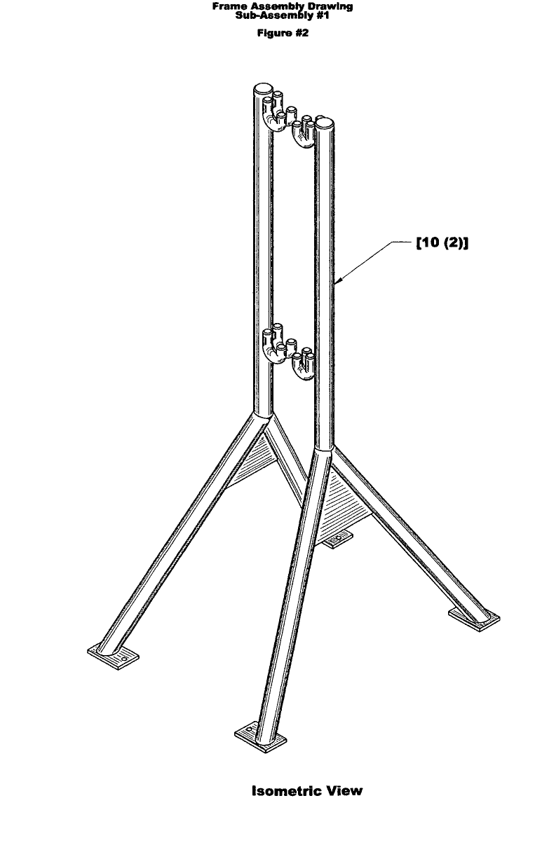

FIG. 2 is a front perspective view of a sub-assembly #1, frame assembly, and its components. Considerations for sturdiness and mounting styles enter the picture as once again the anticipated power output is thought of. This style shown will serve well for a frame of an engine producing several thousand feet pounds of torque. Actual construction styles, welded or assembly, materials used and joint fabrication will be a product of design thought for every engine produced. Prototype builds have shown that using two frame side 10 details construction serves well and gives required versatility for the safe mounting of the drive train sub-assembly 2, float chamber sub-assembly 4 and float chain sub-assembly 3. This type of mounting also gives way to multiple engine mounting configurations in the field. If required, this frame style will give many hours of trouble free service especially wanted when the overall engine may well be stationed under the ground or body of liquid.

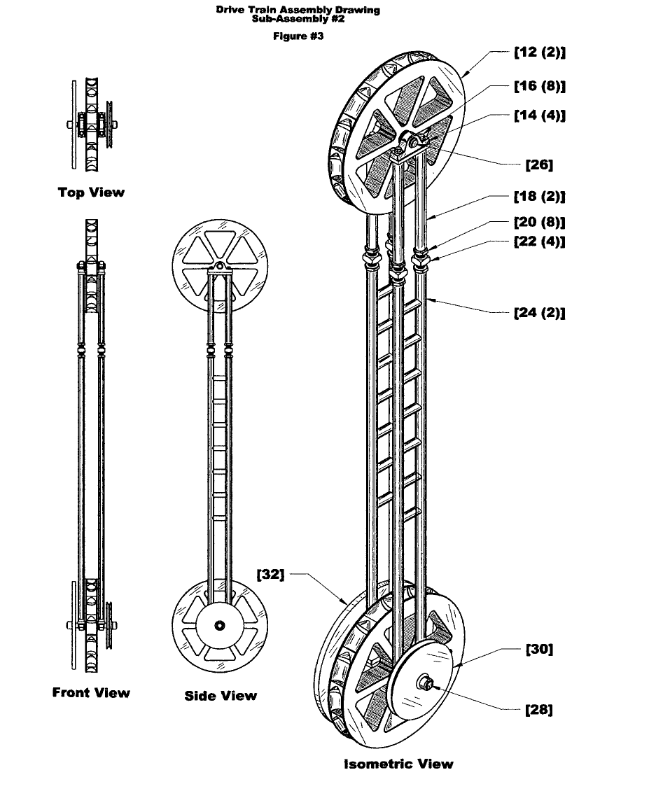

FIG. 3 is a front perspective view of a sub-assembly #2, drive train sub-assembly 2 and its components. This sub-assembly is a structure that defines the path that the floats take. A cogged pulley is located at each end of a ridged structure. These pulleys are permitted to freely rotate because each has either a long keyed shaft 28 and pillow block bearing 14 or a keyed shaft 26 and pillow block bearing 14 mounted to them by means of a hex head screw 16 system. As illustrated, the upper post weldment 18 and the lower post weldment 24 relationship is allowed to expand and contract by way of a male turn buckle 22 and jam nut 20 configuration. This expanding and contracting system allows the installer the ability to install the float chain sub-assembly 3. and properly tension it for operation of the engine. Another function of this sub-assembly is to be driven by the buoyancy powered floats and then transform this up-ward force into usable torque with the radii of the cogged pulleys. The bottom cogged pulley is the driven pulley. The float chain sub-assembly 3 pulls through the bottom cogged pulley and its adjoined shaft causing the long keyed shaft 28 to have torque potential and all components attached to it which includes the tool drive pulley and the flywheel 32 all held in place by a male key and a set screw 37.

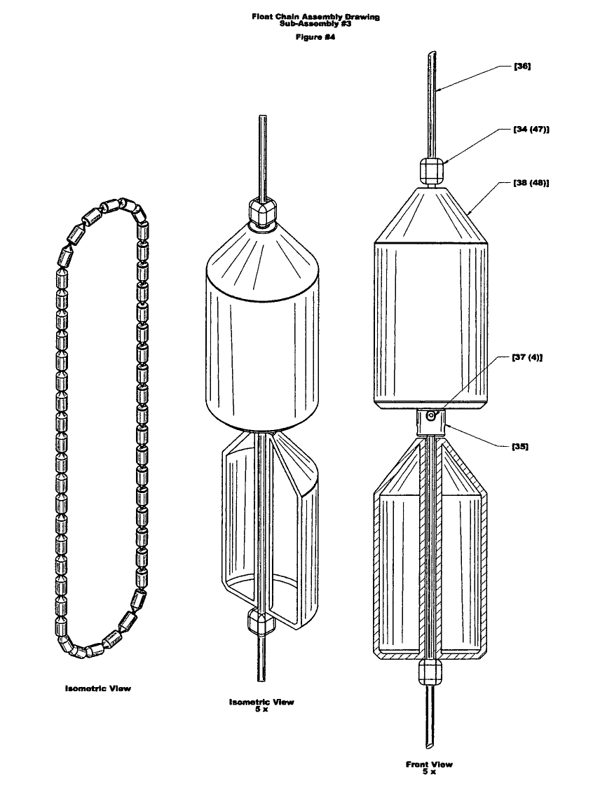

FIG. 4 is a front perspective view of a sub-assembly #3, float chain sub-assembly 3 and its components. At the heart of the engine is the float 38. This float 38, by volume should be lighter than the liquid that it will be exposed to. When this is accomplished the float 38 will float 38. When a number of the floats are coupled to a flexible, central, cord member like the floats are attached to the drive necklace 36 by means of a necklace clamp 34 the power of the floating floats may be added together and the sum of that equation times the radius of the driven cogged pulley will result in kinetic torque power. The torque will also be applied to the long keyed shaft 28, the flywheel 32 and the tool drive pulley. The float chain sub-assembly 3 needs to be coupled end to end and that may be accomplished by means of a necklace ends clamp 35 and set screws. It should be noted now that this final looping and attaching of the necklace ends clamp 35 may only be finished when the drive necklace 36 along with its attached floats and clamps are properly threaded through the float chamber sub-assembly 4 and both un-tensioned cogged pulleys.

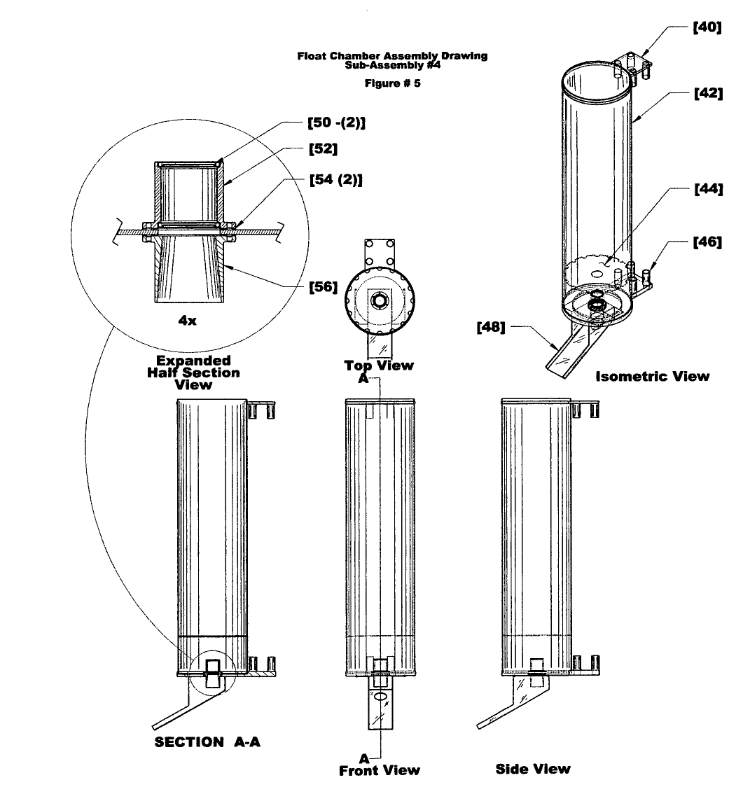

FIG. 5 is a front perspective view of a sub-assembly #4, float chamber sub-assembly 4 and its components. The heart of this sub-assembly is the liquid chamber 42. This liquid chamber 42 is semi-liquid tight only in actual use. To understand this let me describe the movement path of a single float 38. Lets start at the bottom of the entrance tube 56. This entrance tube 56 is tapered to easily accept the float 38 starting its upward path. The float 38 passes through the entrance tube 56, through the exhaust sealing gasket 54, upward through the through-hole of the bottom plate of the liquid chamber 42, upward through another exhaust sealing gasket 54 and proceeds to come in contact with a gland shaft seal 50 (one of two). It is this gland shaft seal 50 that, when a float 38 is positioned within, stops liquid from escaping from the liquid chamber 42, disrupting a downward force of escaping liquid acting upon all exposed floats, and allows buoyancy to influence the submerged floats. The float 38 then proceeds upward through the seal mount 52 and comes contact with another gland shaft seal 50. This second seal is positioned with the seal mount 52 in a way that permits the condition that there is always at least one float 38 in contact with a gland shaft seal 50 at all times of operation and this permits a continuous physical force of buoyancy to be applied to all submerged floats. Shortly after exiting the second gland shaft seal 50 the float 38 goes the a hole that is in the flow plate 44. The flow plate 44 serves as disrupter of possible downward liquid flow exposed directly to the “just entering” floats. The float 38 proceeds upward through the liquid and finally rises out of the liquid from the top surface and is piloted around the top cogged pulley for a path of 180° and then is drawn downward by not only the energy of being coupled to the drive necklace 36 but also by gravity. Gravity plays a part in the equation of “power calculation produced” because these downward floats are clamped to the drive necklace 36 and they weigh more than their counterpart on the opposite side of the float 38 necklace rising upward. The float 38 chain necklace being coupled end to end assures that this sequence of float 38 positions will repeat in a continuous mode of operation. This float 38 chamber is held in place and securely assembled to the drive train sub-assembly 2 by means of the top mount 40 and lower mount 46. The small amount of exhaust liquid is directed away from the working unit by means of the exhaust ramp 48.

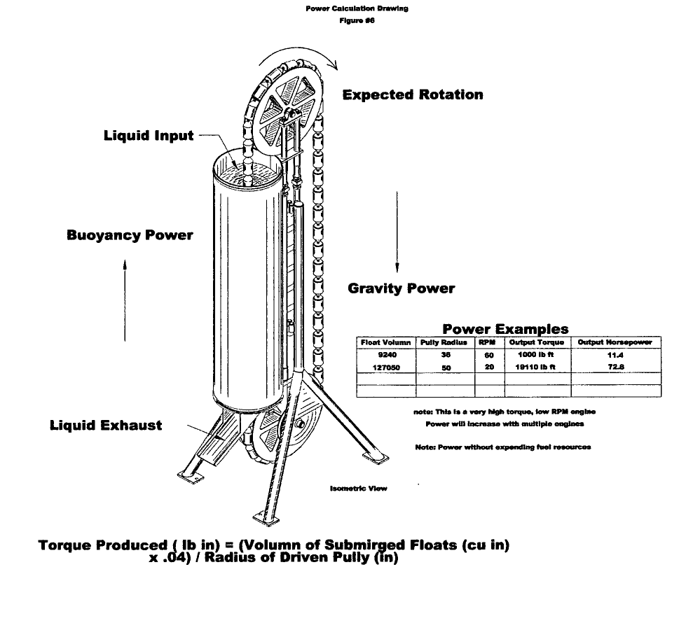

FIG. 6 is a front perspective view of a drawing showing power calculation examples. Along with a few examples of possible power extracted by the engine, this drawing also shows general rotating directions and required liquid level. General conditions for optimum running and maximum energy out are, expose as much floatable volume as possible in as much liquid height as possible. The liquid may be of many configurations. Design consideration should be given so that the side walls of the liquid chamber 42 are of ample distance away from the floats so that any downward exhaust flow could be directed away from the floats by the flow plate 44. Again a simplistic goal would be to have use a liquid that weighs the most per cubic inch of volume yet has a viscosity that would allow anticipated float 38 rising speed. It should be noted that water works well but special formulations of liquid could result in more power.

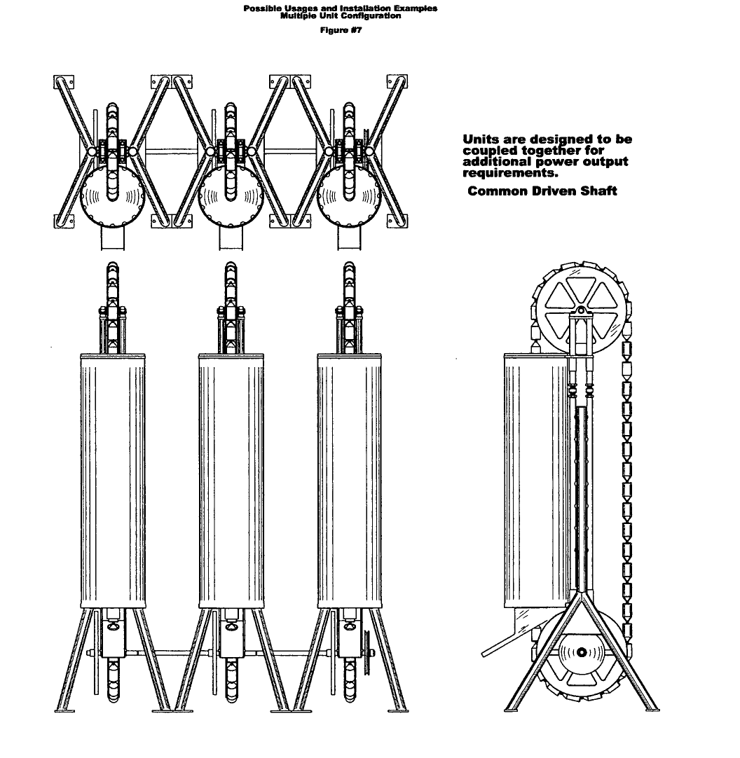

FIG. 7 is a front perspective view of a drawing showing possible usages and installation examples—multiple unit configuration. When the end user has decided how much energy they need to be generated, consideration for multiple units, linked by common or coupled bottom driven shafts should be evaluated.

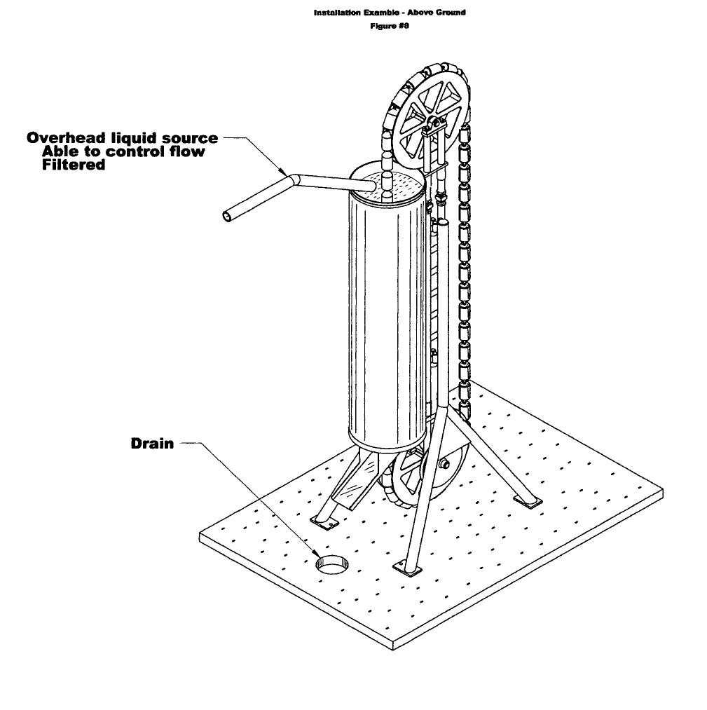

FIG. 8 is a front perspective view of a drawing showing possible usages and installation examples above ground. This drawing displays a very basic installation of the Philippians 419 Engine.

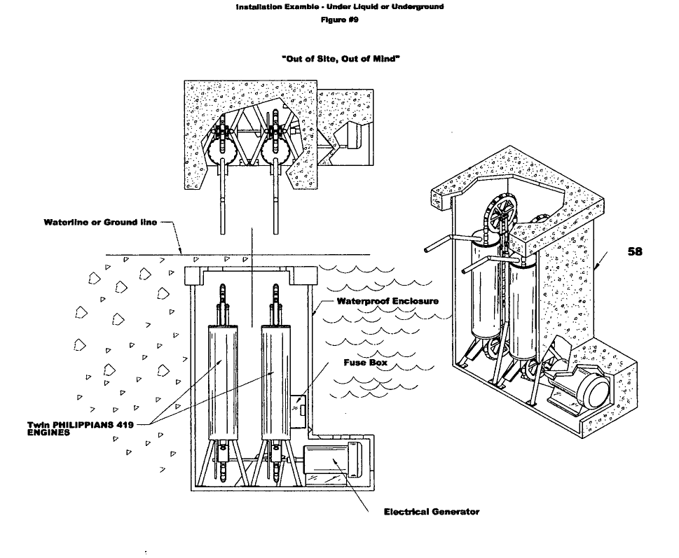

FIG. 9 is a front perspective view of a drawing showing possible usages and installation examples under liquid or underground. This drawing shows a twin unit installation that may be installed inside of an engine room 58 underground or below the surface of a body of liquid. This would meet several of the goals of this engine. The environment would be clean, the engines would be safe from weather and or vandals and the end user would be self reliant for electricity, pumped water and “just energy” for what ever they wish.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A philippians 419 engine—power generation for generating energy and power, comprising:
means for supplying a sturdy support for the other sub-assemblies while also allowing the installer to adjust somewhat the height of the overall unit and the location of the foot mounting feet. the design also accommodates multiple side-by-side installations;
means for providing to the float chain sub-assembly a standard path of travel. this sub-assembly also transmits the power of the driven floats into torque by means of a cogged pulley and axle. another function of this sub-assembly is to provide a means of transporting the torque produced by the engine outwards, to a machine or tool thus doing work for the operator as to their want. the assembled location of this sub-assembly enables the rotating float chain sub-assembly to be exposed to two separate environments, wet and dry. the assembly also allows ease of installation of the float chain assembly (element #3) and proper tensioning of the float chain assembly (element #3) after proper coupling for full functioning operating of the Philippians 419 engine, securely hooked to said means for supplying a sturdy support for the other sub-assemblies while also allowing the installer to adjust somewhat the height of the overall unit and the location of the foot mounting feet. the design also accommodates multiple side-by-side installations;
means for transmitting the upward buoyancy power and the downward gravitational power into the traveling floats so that those powers will drive the cogged pulley within the drive train sub-assembly. this assembly must have the ability to be installed before coupling the ends together. this timed coupling permits the floats to be exposed to two environments, wet and dry. this allows continuing rotation of the floats through the two environments, rollably encircling to said means for providing to the float chain sub-assembly a standard path of travel. this sub-assembly also transmits the power of the driven floats into torque by means of a cogged pulley and axle. another function of this sub-assembly is to provide a means of transporting the torque produced by the engine outwards, to a machine or tool thus doing work for the operator as to their want. the assembled location of this sub-assembly enables the rotating float chain sub-assembly to be exposed to two separate environments, wet and dry. the assembly also allows ease of installation of the float chain assembly (element #3) and proper tensioning of the float chain assembly (element #3) after proper coupling for full functioning operating of the philippians 419 engine;
means for providing to the float chain sub-assembly (element #3) an environment of liquid where the physical phenomenon of buoyance takes place. it is also the function of this sub-assembly to provide a “minimum” liquid leak vessel thus greatly reducing the amount of liquid needed to be replenished through the actions of the float chain sub-assembly by limiting a downward force of liquid trying to escape throughout the chamber's bottom face, float entrance hole. this liquid environment provides “full buoyancy power” to the floats even though there might not be a natural body of liquid near by. this portability of buoyancy power makes installation possible almost every where on earth, rigidly assembled to said means for providing to the float chain sub-assembly a standard path of travel. this sub-assembly also transmits the power of the driven floats into torque by means of a cogged pulley and axle. another function of this sub-assembly is to provide a means of transporting the torque produced by the engine outwards, to a machine or tool thus doing work for the operator as to their want. the assembled location of this sub-assembly enables the rotating float chain sub-assembly to be exposed to two separate environments, wet and dry. the assembly also allows ease of installation of the float chain assembly (element #3) and proper tensioning of the float chain assembly (element #3) after proper coupling for full functioning operating of the philippians 419 engine;
means for providing to the drive train sub-assembly (element #2) a firm, sturdy base. this is important for the philippians 419 engine produces much torque and power. the modular design of this frame and its relationship to the other sub-assemblies promote easy assembly and disassembly for any and all maintenance. the design allows for multiple engine units to be configured by the installer, structurally connected to said means for supplying a sturdy support for the other sub-assemblies while also allowing the installer to adjust somewhat the height of the overall unit and the location of the foot mounting feet. the design also accommodates multiple side-by-side installations;
means for piloting the float chain assembly around both ends of this sub-assembly. the cog forms around the parameter of the pulley secure the floats ensuring that the drive force of the floats is transferred to the driven pulley. the radius distance of this element is a major component in the equation measuring torque output of the philippian 419 engine;
means for enabling smooth rotation of the cogged pulleys (element # 12) around axles (element 26 & 28);
means for securely mounting the tensioned pulley (element 12). this weldment is designed to accept a male turn buckle (element #22) so that the float chain assembly (element #3) may be taunt and secure when in rotation and the engine is functional, rigidly assembled to said means for providing to the float chain sub-assembly a standard path of travel. this sub-assembly also transmits the power of the driven floats into torque by means of a cogged pulley and axle. another function of this sub-assembly is to provide a means of transporting the torque produced by the engine outwards, to a machine or tool thus doing work for the operator as to their want. the assembled location of this sub-assembly enables the rotating float chain sub-assembly to be exposed to two separate environments, wet and dry. the assembly also allows ease of installation of the float chain assembly (element #3) and proper tensioning of the float chain assembly (element #3) after proper coupling for full functioning operating of the philippians 419 engine;
means for compressing and extending both the upper post assembly (element #18) and lower post assembly (element # 24). the purpose of this mechanical travel is to make taunt the float chain assembly (element #3) and to remove the tautness of the float chain drive (element #3) for installation and maintenance practices;
means for securely mounting the driven pulley element 12). this weldment is designed to accept a male turn buckle (element #22) so that the float chain assembly may be taunt and secure when in rotation, rigidly assembled to said means for compressing and extending both the upper post assembly (element #18) and lower post assembly (element # 24) the purpose of this mechanical travel is to make taunt the float chain assembly (element #3) and to remove the tautness of the float chain drive (element #3) for installation and maintenance practices, rigidly assembled to said means for securely mounting the tensioned pulley (element 12). this weldment is designed to accept a male turn buckle (element #22) so that the float chain assembly (element #3) may be taunt and secure when in rotation and the engine is functional, and rigidly assembled to said means for enabling smooth rotation of the cogged pulleys (element # 12) around axles (element 26 & 28);
means for providing a central axes of rotation for the tensioned pulley (element #12) and to transfer beam load to pillow block bearing (element #14). central key assures full torque transfer from pulley to shaft, correctly positioned to said means for securely mounting the tensioned pulley (element 12). this weldment is designed to accept a male turn buckle (element #22) so that the float chain assembly (element #3) may be taunt and secure when in rotation and the engine is functional;
means for providing a central axes of rotation for the tensioned pulley (element #12) and to transfer beam load to pillow block bearing (element #14). central key assures full torque transfer from pulley to shaft (element #28) and tool drive pulley (element #30) and flywheel (element #32), correctly assembled to said means for enabling smooth rotation of the cogged pulleys (element # 12) around axles (element 26 & 28), and rigidly assembled to said means for piloting the float chain assembly around both ends of this sub-assembly. the cog forms around the parameter of the pulley secure the floats ensuring that the drive force of the floats is transferred to the driven pulley. the radius distance of this element is a major component in the equation measuring torque output of the philippian 419 engine;
means for providing a means to transfer the output power generated by the philippians 419 engine to a tool of choice by the user, rigidly assembled to said means for providing a central axes of rotation for the tensioned pulley (element #12) and to transfer beam load to pillow block bearing (element #14). central key assures full torque transfer from pulley to shaft (element #28) and tool drive pulley (element #30 and flywheel (element #32);
means for sustaining smooth and constant motion of the float chain sub-assembly (element #3) to the long keyed shaft (element #28), rigidly assembled to said means for providing a central axes of rotation for the tensioned pulley (element #12) and to transfer beam load to pillow block bearing (element #14). central key assures full torque transfer from pulley to shaft (element #28) and tool drive pulley (element #30 and flywheel (element #32);
means for two purposes. the first purpose is to space the floats (element #38) apart from each other at a distance of its height only. the second is that this necklace clamp secures itself in a mechanical fashion by a clamp force greater than the expected torque value of the engine;
means for providing a central, continuous loop of substantial strength, that floats (element # 38) and necklace clamp (element # 34) may be attached to in a continuous line from end to end. it is this loop that collects and gathers all the power from individual floats and transmits that total power to the driven pulley (element #12), threadably clamped to said means for two purposes. the first purpose is to space the floats (element #38) apart from each other at a distance of its height only. the second is that this necklace clamp secures itself in a mechanical fashion by a clamp force greater than the expected torque value of the engine, and subassembly placed to said means for transmitting the upward buoyancy power and the downward gravitational power into the traveling floats so that those powers will drive the cogged pulley within the drive train sub-assembly. this assembly must have the ability to be installed before coupling the ends together. this timed coupling permits the floats to be exposed to two environments, wet and dry. this allows continuing rotation of the floats through the two environments;
means for allowing the assembler to connect securely the two ends of the drive necklace (element # 36). when the opposing set screws are properly torqued a self jamming situation is in place, firmly attached to said means for providing a central, continuous loop of substantial strength, that floats (element # 38) and necklace clamp (element # 34 may be attached to in a continuous line from end to end. it is this loop that collects and gathers all the power from individual floats and transmits that total power to the driven pulley (element #12);
means for securing the ends of the drive necklace (element #36) to each other while maintaining the same height as the regular necklace clamps (element #34), rigidly connected to said means for allowing the assembler to connect securely the two ends of the drive necklace (element # 36). when the opposing set screws are properly torqued a self jamming situation is in place;
means for producing buoyancy lift and gravitational pull and then transmits those forces to the drive necklace (element #36) by first bumping into necklace clamp (element #34), threadably placed to said means for providing a central, continuous loop of substantial strength, that floats (element # 38) and necklace clamp (element # 34) may be attached to in a continuous line from end to end. it is this loop that collects and gathers all the power from individual floats and transmits that total power to the driven pulley (element #12);
means for securing the top of the liquid chamber (element #42) to the drive train sub-assembly (element #18), subassembly placed to said means for providing to the float chain sub-assembly (element #3) an environment of liquid where the physical phenomenon of buoyance takes place. it is also the function of this sub-assembly to provide a “minimum” liquid leak vessel thus greatly reducing the amount of liquid needed to be replenished through the actions of the float chain sub-assembly by limiting a downward force of liquid trying to escape throughout the chamber's bottom face, float entrance hole. this liquid environment provides “full buoyancy power” to the floats even though there might not be a natural body of liquid near by. this portability of buoyancy power makes installation possible almost every where on earth;
means for providing the engine with an environment to flood liquid over the enclosed stationary floats. this chamber also houses the components (elements #50, 52, 54, and 56) that limits the flow of escaping liquid downward. this chamber will be capable of accepting a small amount of liquid through its top opening, rigidly assembled to said means for securing the top of the liquid chamber element #42) to the drive train sub-assembly element #18);
means for directing the downward flow of the liquid that wants to flow out the bottom of the chamber when there is no floats sealed by either of the mounted lip seals (element #50). this element has flow holes about its outer diameter and the majority of escaping liquid uses this path and this path does not exert a down ward force upon the in-coming and soon to be rising floats (element #38.), rigidly attached to said means for providing the engine with an environment to flood liquid over the enclosed stationary floats. this chamber also houses the components (elements #50, 52, 54, and 56) that limits the flow of escaping liquid downward. this chamber will be capable of accepting a small amount of liquid through its top opening;
means for to mount the liquid chamber (element # 42) securely to the lower post assembly (element # 24) another function of this mount is to provide a place to mount the exhaust ramp (element #48), rigidly assembled to said means for securing the top of the liquid chamber (element #42) to the drive train sub-assembly (element #18);
means for directing the exhaust flow of liquid away from the mechanics of the engine and to provide a mounting point for future installation of exhaust components;
means for sealing the float chamber (element #42) against substantial leaking of liquid when the incoming floats enter the liquid chamber. two of these elements are required so that the exhaust opening of the liquid chamber has always at least one float in place to eliminate gross exhaust flow;
means for the secure mounting of the two gland shaft seals (element #50). the spacing of the seals is critical and should be such that at least one float (element #38) is captured by at least one seal all the time of running, sealingly placed to said means for sealing the float chamber (element #42) against substantial leaking of liquid when the incoming floats enter the liquid chamber. two of these elements are required so that the exhaust opening of the liquid chamber has always at least one float in place to eliminate gross exhaust flow, and rigidly assembled to said means for providing the engine with an environment to flood liquid over the enclosed stationary floats. this chamber also houses the components (elements #50, 52, 54, and 56) that limits the flow of escaping liquid downward. this chamber will be capable of accepting a small amount of liquid through its top opening;
means for forming a non-leak connection between the seal mount (element #52) and the bottom plate of the liquid chamber (element #42) and again between the liquid chamber (element #42) and the entrance tube (element #56), correctly captured to said means for the secure mounting of the two gland shaft seals (element #50). the spacing of the seals is critical and should be such that at least one float (element #38) is captured by at least one seal all the time of running;
means for to provide an alignment bore to secure the fact that the entering floats (element #38) will be positioned correctly when entering the gland shaft seals (element #50), rigidly connected to said means for forming a non-leak connection between the seal mount (element #52) and the bottom plate of the liquid chamber (element #42) and again between the liquid chamber (element #42) and the entrance tube (element #56); and
means for to provide protection and security for the engine when the engine system is installed underground or under the top surface of a liquid. this unit could be used for safety and security of even an above ground installation. this engine room has ample room from within to house the appropriate tools and gear (examples: generator, alternator, switchgear, fuse box, regulators, ect.) the end user warrants from their needs. this element allows for a clear and non-environment disrupting installation. this unit provides protection against the natural elements and or vandels. this element allows for all external connections for both input and output requirements, rigidly mounted to said means for supplying a sturdy support for the other sub-assemblies while also allowing the installer to adjust somewhat the height of the overall unit and the location of the foot mounting feet. the design also accommodates multiple side-by-side installations.

2. The philippians 419 engine—power generation in accordance with claim 1, wherein said means for supplying a sturdy support for the other sub-assemblies while also allowing the installer to adjust somewhat the height of the overall unit and the location of the foot mounting feet. the design also accommodates multiple side-by-side installations comprises a rust protected, lh and rh identical, welded construction, floor mountable frame sub-assembly.

3. The philippians 419 engine—power generation in accordance with claim 1, wherein said means for providing to the float chain sub-assembly a standard path of travel. this sub-assembly also transmits the power of the driven floats into torque by means of a cogged pulley and axle. another function of this sub-assembly is to provide a means of transporting the torque produced by the engine outwards, to a machine or tool thus doing work for the operator as to their want. the assembled location of this sub-assembly enables the rotating float chain sub-assembly to be exposed to two separate environments, wet and dry. the assembly also allows ease of installation of the float chain assembly (element #3) and proper tensioning of the float chain assembly (element #3) after proper coupling for full functioning operating of the Philippians 419 engine comprises a rust protected, adjustable, rh and lh struts identical drive train sub-assembly.

4. The philippians 419 engine—power generation in accordance with claim 1, wherein said means for transmitting the upward buoyancy power and the downward gravitational power into the traveling floats so that those powers will drive the cogged pulley within the drive train sub-assembly. this assembly must have the ability to be installed before coupling the ends together. this timed coupling permits the floats to be exposed to two environments, wet and dry. this allows continuing rotation of the floats through the two environments comprises a waterproof construction, securely linked to form a loop chain, low maintenance, easily re-designed for added power, simple design, serviceable end to end coupling float chain sub-assembly.

5. The philippians 419 engine—power generation in accordance with claim 1, wherein said means for providing to the float chain sub-assembly (element #3) an environment of liquid where the physical phenomenon of buoyance takes place. it is also the function of this sub-assembly to provide a “minimum” liquid leak vessel thus greatly reducing the amount of liquid needed to be replenished through the actions of the float chain sub-assembly by limiting a downward force of liquid trying to escape throughout the chamber's bottom face, float entrance hole. this liquid environment provides “full buoyancy power” to the floats even though there might not be a natural body of liquid near by. this portability of buoyancy power makes installation possible almost every where on earth comprises a rust prevented, adjustable mounting height, simple construction, low maintenance, exhaust flow regulated float chamber sub-assembly.

6. The philippians 419 engine—power generation in accordance with claim 1, wherein said means for providing to the drive train sub-assembly (element #2) a firm, sturdy base. this is important for the philippians 419 engine produces much torque and power. the modular design of this frame and its relationship to the other sub-assemblies promote easy assembly and disassembly for any and all maintenance. the design allows for multiple engine units to be configured by the installer comprises a rust protected, welded construction for stability, mounting hole in feet, water tight construction, rh and lh identical, sturdy design frame side.

7. The philippians 419 engine—power generation in accordance with claim 1, wherein said means for piloting the float chain assembly around both ends of this sub-assembly. the cog forms around the parameter of the pulley secure the floats ensuring that the drive force of the floats is transferred to the driven pulley. the radius distance of this element is a major component in the equation measuring torque output of the philippian 419 engine comprises a water resistant, rust protected, multiple float form nests, driven and tensioned pulley are identical, light weight cogged pulley.

8. The philippians 419 engine—power generation in accordance with claim 1, wherein said means for enabling smooth rotation of the cogged pulleys (element # 12) around axles (element 26 & 28) comprises a rust protected, self-lubricated, water tight pillow block bearing.

9. The Philippians 419 engine—power generation in accordance with claim 1, wherein said means for securely mounting the tensioned pulley (element 12). this weldment is designed to accept a male turn buckle (element #22) so that the float chain assembly (element #3) may be taunt and secure when in rotation and the engine is functional comprises a rust protected, machined to accept male turn buckle (element 22), machined to mount pillow block bearing (element 14), rh and lh identical, weldment upper post weldment.

10. The Philippians 419 engine—power generation in accordance with claim 1, wherein said means for compressing and extending both the upper post assembly (element #18) and lower post assembly (element # 24). the purpose of this mechanical travel is to make taunt the float chain assembly (element #3) and to remove the tautness of the float chain drive (element #3) for installation and maintenance practices comprises a rust protected, capable of at least 10″ of travel male turn buckle.

11. The philippians 419 engine—power generation in accordance with claim 1, wherein said means for securely mounting the driven pulley (element 12). this weldment is designed to accept a male turn buckle (element #22) so that the float chain assembly may be taunt and secure when in rotation comprises a rust protected, weldment, machined to accept mounting of pillow block bearing (element 14), machined to accept mounting of turn buckle (element # 22), rh and lh assemblies are identical lower post weldment.

12. The Philippians 419 engine—power generation in accordance with claim 1, wherein said means for providing a central axes of rotation for the tensioned pulley (element #12) and to transfer beam load to pillow block bearing (element #14). central key assures full torque transfer from pulley to shaft comprises a rust protected, same key size as pulley (element #12) keyed shaft.

13. The philippians 419 engine—power generation in accordance with claim 1, wherein said means for providing a central axes of rotation for the tensioned pulley (element #12) and to transfer beam load to pillow block bearing (element #14). central key assures full torque transfer from pulley to shaft (element #28) and tool drive pulley (element #30) and flywheel (element #32) comprises a rust protected, same key size as cogged pulley, drive tool pulley, flywheel long keyed shaft.

14. The Philippians 419 engine—power generation in accordance with claim 1, wherein said means for providing a means to transfer the output power generated by the philippians 419 engine to a tool of choice by the user comprises a rust protected, same keyway as long keyed shaft (element #28) tool drive pulley.

15. The Philippians 419 engine—power generation in accordance with claim 1, wherein said means for sustaining smooth and constant motion of the float chain sub-assembly (element #3) to the long keyed shaft (element #28) comprises a rust protected, diameter equal to pulley, width designed for proper inertia desired during operation flywheel.

16. The Philippians 419 engine—power generation in accordance with claim 1, wherein said means for two purposes. the first purpose is to space the floats (element #38) apart from each other at a distance of its height only. the second is that this necklace clamp secures itself in a mechanical fashion by a clamp force greater than the expected torque value of the engine comprises a rust protected, able to be securely clamped to the necklace (element #36) necklace clamp.

17. The philippians 419 engine—power generation in accordance with claim 1, wherein said means for providing a central, continuous loop of substantial strength, that floats (element # 38) and necklace clamp (element # 34 may be attached to in a continuous line from end to end. it is this loop that collects and gathers all the power from individual floats and transmits that total power to the driven pulley (element #12) comprises a rust protected, flexible, high tensile strength drive necklace.

18. The Philippians 419 engine—power generation in accordance with claim 1, wherein said means for allowing the assembler to connect securely the two ends of the drive necklace (element # 36). when the opposing set screws are properly torqued a self jamming situation is in place comprises a rust protected, self jamming necklace ends clamp.

19. The philippians 419 engine—power generation in accordance with claim 1, wherein said means for securing the ends of the drive necklace (element #36) to each other while maintaining the same height as the regular necklace clamps (element #34) comprises a rust protected set screw.

20. The philippians 419 engine—power generation in accordance with claim 1, wherein said means for producing buoyancy lift and gravitational pull and then transmits those forces to the drive necklace (element #36) by first bumping into necklace clamp (element #34) comprises a rust protected, it will float, it is waterproof, design suited for lip seal sealing over most of the outside diameterer, has center bore for receiving of drive necklace (element # 36), may be hollow yet waterproof, volume determined by anticipated power, number of determined by anticipated power float.

21. The Philippians 419 engine—power generation in accordance with claim 1, wherein said means for securing the top of the liquid chamber (element #42) to the drive train sub-assembly (element #18) comprises a rust protected, weldment top mount.

22. The philippians 419 engine—power generation in accordance with claim 1, wherein said means for providing the engine with an environment to flood liquid over the enclosed stationary floats. this chamber also houses the components (elements #50, 52, 54, and 56) that limits the flow of escaping liquid downward. this chamber will be capable of accepting a small amount of liquid through its top opening comprises a rust protected, round tube, bottom face plate designed to accept the mounting of elements #52, 54, 56) liquid chamber.

23. The philippians 419 engine—power generation in accordance with claim 1, wherein said means for directing the downward flow of the liquid that wants to flow out the bottom of the chamber when there is no floats sealed by either of the mounted lip seals (element #50). this element has flow holes about its outer diameter and the majority of escaping liquid uses this path and this path does not exert a down ward force upon the in-coming and soon to be rising floats (element #38.) comprises a rust protected, centerhole slightly larger that float out side diameter, relief flow thru holes around its out side dia, securely mounted to the inside of the liquid chamber (element # 42), mounted at least 3 heights of the float element #38) from the inside bottom plate surface flow plate.

24. The Philippians 419 engine—power generation in accordance with claim 1, wherein said means for to mount the liquid chamber (element # 42) securely to the lower post assembly (element # 24) another function of this mount is to provide a place to mount the exhaust ramp element #48) comprises a rust protected, welded construction lower mount.

25. The philippians 419 engine—power generation in accordance with claim 1, wherein said means for directing the exhaust flow of liquid away from the mechanics of the engine and to provide a mounting point for future installation of exhaust components comprises a rust protected, center clearance hole for up-coming floats element #38) exhaust ramp.

26. The philippians 419 engine—power generation in accordance with claim 1, wherein said means for sealing the float chamber (element #42) against substantial leaking of liquid when the incoming floats enter the liquid chamber. two of these elements are required so that the exhaust opening of the liquid chamber has always at least one float in place to eliminate gross exhaust flow comprises a rust protected, uni-directional gland gland shaft seal.

27. The philippians 419 engine—power generation in accordance with claim 1, wherein said means for the secure mounting of the two gland shaft seals (element #50). the spacing of the seals is critical and should be such that at least one float (element #38) is captured by at least one seal all the time of running comprises a rust protected, two press in bore for radial lip seals (element #50, seal placement separation is 1½ times the height if a float (element #38), both seals mounted with pressure side up, through bore to be slightly larger that outside diameter of a float so as to limit exhaust flow of liquid seal mount.

28. The Philippians 419 engine—power generation in accordance with claim 1, wherein said means for forming a non-leak connection between the seal mount (element #52 and the bottom plate of the liquid chamber (element #42 and again between the liquid chamber (element #42) and the entrance tube (element #56) comprises a water resistant exhaust sealing gasket.

29. The philippians 419 engine—power generation in accordance with claim 1, wherein said means for to provide an alignment bore to secure the fact that the entering floats (element #38) will be positioned correctly when entering the gland shaft seals (element #50) comprises a rust protected, tapered bore, minor bore to be slightly larger than float element #38) entrance tube.

30. The philippians 419 engine—power generation in accordance with claim 1, wherein said means for to provide protection and security for the engine when the engine system is installed underground or under the top surface of a liquid. this unit could be used for safety and security of even an above ground installation. this engine room has ample room from within to house the appropriate tools and gear (examples: generator, alternator, switchgear, fuse box, regulators, ect.) the end user warrants from their needs. this element allows for a clear and non-environment disrupting installation. this unit provides protection against the natural elements and or vandels. this element allows for all external connections for both input and output requirements comprises a water tight, service lid engine room.

31. A philippians 419 engine—power generation for generating energy and power, comprising:
a rust protected, lh and rh identical, welded construction, floor mountable frame sub-assembly, for supplying a sturdy support for the other sub-assemblies while also allowing the installer to adjust somewhat the height of the overall unit and the location of the foot mounting feet. the design also accommodates multiple side-by-side installations;
a rust protected, adjustable, rh and lh struts identical drive train sub-assembly, for providing to the float chain sub-assembly a standard path of travel. this sub-assembly also transmits the power of the driven floats into torque by means of a cogged pulley and axle. another function of this sub-assembly is to provide a means of transporting the torque produced by the engine outwards, to a machine or tool thus doing work for the operator as to their want. the assembled location of this sub-assembly enables the rotating float chain sub-assembly to be exposed to two separate environments, wet and dry. the assembly also allows ease of installation of the float chain assembly (element #3) and proper tensioning of the float chain assembly (element #3) after proper coupling for full functioning operating of the Philippians 419 engine, securely hooked to said frame sub-assembly;
a waterproof construction, securely linked to form a loop chain, low maintenance, easily re-designed for added power, simple design, serviceable end to end coupling float chain sub-assembly, for transmitting the upward buoyancy power and the downward gravitational power into the traveling floats so that those powers will drive the cogged pulley within the drive train sub-assembly. this assembly must have the ability to be installed before coupling the ends together. this timed coupling permits the floats to be exposed to two environments, wet and dry. this allows continuing rotation of the floats through the two environments, rollably encircling to said drive train sub-assembly;
a rust prevented, adjustable mounting height, simple construction, low maintenance, exhaust flow regulated float chamber sub-assembly, for providing to the float chain sub-assembly (element #3) an environment of liquid where the physical phenomenon of buoyance takes place. it is also the function of this sub-assembly to provide a “minimum” liquid leak vessel thus greatly reducing the amount of liquid needed to be replenished through the actions of the float chain sub-assembly by limiting a downward force of liquid trying to escape throughout the chamber's bottom face, float entrance hole. this liquid environment provides “full buoyancy power” to the floats even though there might not be a natural body of liquid near by. this portability of buoyancy power makes installation possible almost every where on earth, rigidly assembled to said drive train sub-assembly;
a rust protected, welded construction for stability, mounting hole in feet, water tight construction, rh and lh identical, sturdy design frame side, for providing to the drive train sub-assembly (element #2) a firm, sturdy base. this is important for the philippians 419 engine produces much torque and power. the modular design of this frame and its relationship to the other sub-assemblies promote easy assembly and disassembly for any and all maintenance. the design allows for multiple engine units to be configured by the installer, structurally connected to said frame sub-assembly;
a water resistant, rust protected, multiple float form nests, driven and tensioned pulley are identical, light weight cogged pulley, for piloting the float chain assembly around both ends of this sub-assembly. the cog forms around the parameter of the pulley secure the floats ensuring that the drive force of the floats is transferred to the driven pulley. the radius distance of this element is a major component in the equation measuring torque output of the philippian 419 engine;
a rust protected, self-lubricated, water tight pillow block bearing, for enabling smooth rotation of the cogged pulleys (element # 12) around axles element 26 & 28);
a rust protected, machined to accept male turn buckle (element 22), machined to mount pillow block bearing (element 14), rh and lh identical, weldment upper post weldment, for securely mounting the tensioned pulley (element 12). this weldment is designed to accept a male turn buckle (element #22 so that the float chain assembly (element #3) may be taunt and secure when in rotation and the engine is functional, rigidly assembled to said drive train sub-assembly;
a rust protected, capable of at least 10″ of travel male turn buckle, for compressing and extending both the upper post assembly (element #18) and lower post assembly (element # 24). the purpose of this mechanical travel is to make taunt the float chain assembly (element #3) and to remove the tautness of the float chain drive (element #3) for installation and maintenance practices;
a rust protected, weldment, machined to accept mounting of pillow block bearing (element 14), machined to accept mounting of turn buckle (element # 22), rh and lh assemblies are identical lower post weldment, for securely mounting the driven pulley (element 12). this weldment is designed to accept a male turn buckle (element #22) so that the float chain assembly may be taunt and secure when in rotation, rigidly assembled to said male turn buckle, rigidly assembled to said upper post weldment, and rigidly assembled to said pillow block bearing;
a rust protected, same key size as pulley (element #12) keyed shaft, for providing a central axes of rotation for the tensioned pulley (element #12 and to transfer beam load to pillow block bearing (element #14). central key assures full torque transfer from pulley to shaft, correctly positioned to said upper post weldment;
a rust protected, same key size as cogged pulley, drive tool pulley, flywheel long keyed shaft, for providing a central axes of rotation for the tensioned pulley (element #12) and to transfer beam load to pillow block bearing (element #14). central key assures full torque transfer from pulley to shaft (element #28) and tool drive pulley (element #30) and flywheel (element #32), correctly assembled to said pillow block bearing, and rigidly assembled to said cogged pulley;
a rust protected, same keyway as long keyed shaft (element #28) tool drive pulley, for providing a means to transfer the output power generated by the philippians 419 engine to a tool of choice by the user, rigidly assembled to said long keyed shaft;
a rust protected, diameter equal to pulley, width designed for proper inertia desired during operation flywheel, for sustaining smooth and constant motion of the float chain sub-assembly (element #3) to the long keyed shaft (element #28), rigidly assembled to said long keyed shaft;
a rust protected, able to be securely clamped to the necklace (element #36) necklace clamp, for two purposes. the first purpose is to space the floats (element #38) apart from each other at a distance of its height only. the second is that this necklace clamp secures itself in a mechanical fashion by a clamp force greater than the expected torque value of the engine;
a rust protected, flexible, high tensile strength drive necklace, for providing a central, continuous loop of substantial strength, that floats (element # 38) and necklace clamp (element # 34) may be attached to in a continuous line from ene to end. it is this loop that collects and gathers all the power from individual floats and transmits that total power to the driven pulley (element #12), threadably clamped to said necklace clamp, and subassembly placed to said float chain sub-assembly;
a rust protected, self jamming necklace ends clamp, for allowing the assembler to connect securely the two ends of the drive necklace (element # 36). when the opposing set screws are properly torqued a self jamming situation is in place, firmly attached to said drive necklace;
a rust protected set screw, for securing the ends of the drive necklace (element #36) to each other while maintaining the same height as the regular necklace clamps (element #34), rigidly connected to said necklace ends clamp;
a rust protected, it will float, it is waterproof, design suited for lip seal sealing over most of the outside diameter, has center bore for receiving of drive necklace (element # 36), may be hollow yet waterproof, volume determined by anticipated power, number of determined by anticipated power float, for producing buoyancy lift and gravitational pull and then transmits thoses forces to the drive necklace (element #36) by first bumping into necklace clamp (element #34), threadably placed to said drive necklace;
a rust protected, weldment top mount, for securing the top of the liquid chamber (element #42 to the drive train sub-assembly (element #18), subassembly placed to said float chamber sub-assembly;
a rust protected, round tube, bottom face plate designed to accept the mounting of elements #52, 54, 56) liquid chamber, for providing the engine with an environment to flood liquid over the enclosed stationary floats. this chamber also houses the components (elements #50, 52, 54, and 56) that limits the flow of escaping liquid downward. this chamber will be capable of accepting a small amount of liquid through its top opening, rigidly assembled to said top mount;
a rust protected, centerhole slightly larger that float out side diameter, relief flow thru holes around its out side dia, securely mounted to the inside of the liquid chamber (element # 42), mounted at least 3 heights of the float (element #38) from the inside bottom plate surface flow plate, for directing the downward flow of the liquid that wants to flow out the bottom of the chamber when there is no floats sealed by either of the mounted lip seals (element #50). this element has flow holes about its outer diameter and the majority of escaping liquid uses this path and this path does not exert a down ward force upon the in-coming and soon to be rising floats (element #38.), rigidly attached to said liquid chamber;
a rust protected, welded construction lower mount, for to mount the liquid chamber (element # 42 securely to the lower post assembly (element # 24). another function of this mount is to provide a place to mount the exhaust ramp (element #48), rigidly assembled to said top mount;
a rust protected, center clearance hole for up-coming floats (element #38) exhaust ramp, for directing the exhaust flow of liquid away from the mechanics of the engine and to provide a mounting point for future installation of exhaust components;
a rust protected, uni-directional gland gland shaft seal, for sealing the float chamber (element #42) against substantial leaking of liquid when the incoming floats enter the liquid chamber. two of these elements are required so that the exhaust opening of the liquid chamber has always at least one float in place to eliminate gross exhaust flow;
a rust protected, two press in bore for radial lip seals (element #50, seal placement separation is 1½ times the height if a float (element #38), both seals mounted with pressure side up, through bore to be slightly larger that outside diameter of a float so as to limit exhaust flow of liquid seal mount, for the secure mounting of the two gland shaft seals (element #50). the spacing of the seals is critical and should be such that at least one float (element #38) is captured by at least one seal all the time of running, sealingly placed to said gland shaft seal, and rigidly assembled to said liquid chamber;
a water resistant exhaust sealing gasket, for forming a non-leak connection between the seal mount (element #52) and the bottom plate of the liquid chamber (element #42) and again between the liquid chamber (element #42) and the entrance tube (element #56), correctly captured to said seal mount;
a rust protected, tapered bore, minor bore to be slightly larger than float element #38) entrance tube, for to provide an alignment bore to secure the fact that the entering floats (element #38) will be positioned correctly when entering the gland shaft seals (element #50), rigidly connected to said exhaust sealing gasket; and
a water tight, service lid engine room, for to provide protection and security for the engine when the engine system is installed underground or under the top surface of a liquid. this unit could be used for safety and security of even an above ground installation. this engine room has ample room from within to house the appropriate tools and gear (examples: generator, alternator, switchgear, fuse box, regulators, ect.) the end user warrants from their needs. this element allows for a clear and non-environment disrupting installation. this unit provides protection against the natural elements and or vandels. this element allows for all external connections for both input and output requirements, rigidly mounted to said frame sub-assembly.

32. A philippians 419 engine—power generation for generating energy and power, comprising:
a rust protected, lh and rh identical, welded construction, floor mountable frame sub-assembly, for supplying a sturdy support for the other sub-assemblies while also allowing the installer to adjust somewhat the height of the overall unit and the location of the foot mounting feet. the design also accommodates multiple side-by-side installations;
a rust protected, adjustable, rh and lh struts identical drive train sub-assembly, for providing to the float chain sub-assembly a standard path of travel. this sub-assembly also transmits the power of the driven floats into torque by means of a cogged pulley and axle. another function of this sub-assembly is to provide a means of transporting the torque produced by the engine outwards, to a machine or tool thus doing work for the operator as to their want. the assembled location of this sub-assembly enables the rotating float chain sub-assembly to be exposed to two separate environments, wet and dry. the assembly also allows ease of installation of the float chain assembly (element #3) and proper tensioning of the float chain assembly (element #3) after proper coupling for full functioning operating of the philippians 419 engine, securely hooked to said frame sub-assembly;
a waterproof construction, securely linked to form a loop chain, low maintenance, easily re-designed for added power, simple design, serviceable end to end coupling float chain sub-assembly, for transmitting the upward buoyancy power and the downward gravitational power into the traveling floats so that those powers will drive the cogged pulley within the drive train sub-assembly. this assembly must have the ability to be installed before coupling the ends together. this timed coupling permits the floats to be exposed to two environments, wet and dry. this allows continuing rotation of the floats through the two environments, rollably encircling to said drive train sub-assembly;
a rust prevented, adjustable mounting height, simple construction, low maintenance, exhaust flow regulated float chamber sub-assembly, for providing to the float chain sub-assembly (element #3) an environment of liquid where the physical phenomenon of buoyance takes place. it is also the function of this sub-assembly to provide a “minimum” liquid leak vessel thus greatly reducing the amount of liquid needed to be replenished through the actions of the float chain sub-assembly by limiting a downward force of liquid trying to escape throughout the chamber's bottom face, float entrance hole. this liquid environment provides “full buoyancy power” to the floats even though there might not be a natural body of liquid near by. this portability of buoyancy power makes installation possible almost every where on earth, rigidly assembled to said drive train sub-assembly;
a rust protected, welded construction for stability, mounting hole in feet, water tight construction, rh and lh identical, sturdy design frame side, for providing to the drive train sub-assembly (element #2) a firm, sturdy base. this is important for the philippians 419 engine produces much torque and power. the modular design of this frame and its relationship to the other sub-assemblies promote easy assembly and disassembly for any and all maintenance. the design allows for multiple engine units to be configured by the installer, structurally connected to said frame sub-assembly;
a water resistant, rust protected, multiple float form nests, driven and tensioned pulley are identical, light weight cogged pulley, for piloting the float chain assembly around both ends of this sub-assembly. the cog forms around the parameter of the pulley secure the floats ensuring that the drive force of the floats is transferred to the driven pulley. the radius distance of this element is a major component in the equation measuring torque output of the philippian 419 engine;
a rust protected, self-lubricated, water tight pillow block bearing, for enabling smooth rotation of the cogged pulleys (element # 12) around axles element 26 & 28);
a rust protected, machined to accept male turn buckle (element 22), machined to mount pillow block bearing (element 14), rh and lh identical, weldment upper post weldment, for securely mounting the tensioned pulley (element 12). this weldment is designed to accept a male turn buckle (element #22 so that the float chain assembly (element #3) may be taunt and secure when in rotation and the engine is functional, rigidly assembled to said drive train sub-assembly;
a rust protected, capable of at least 10″ of travel male turn buckle, for compressing and extending both the upper post assembly (element #18) and lower post assembly (element # 24). the purpose of this mechanical travel is to make taunt the float chain assembly (element #3) and to remove the tautness of the float chain drive (element #3) for installation and maintenance practices;
a rust protected, weldment, machined to accept mounting of pillow block bearing (element 14), machined to accept mounting of turn buckle (element # 22), rh and lh assemblies are identical lower post weldment, for securely mounting the driven pulley (element 12). this weldment is designed to accept a male turn buckle (element #22) so that the float chain assembly may be taunt and secure when in rotation, rigidly assembled to said male turn buckle, rigidly assembled to said upper post weldment, and rigidly assembled to said pillow block bearing;
a rust protected, same key size as pulley (element #12) keyed shaft, for providing a central axes of rotation for the tensioned pulley (element #12 and to transfer beam load to pillow block bearing (element #14). central key assures full torque transfer from pulley to shaft, correctly positioned to said upper post weldment;
a rust protected, same key size as cogged pulley, drive tool pulley, flywheel long keyed shaft, for providing a central axes of rotation for the tensioned pulley (element #12) and to transfer beam load to pillow block bearing (element #14). central key assures full torque transfer from pulley to shaft (element #28) and tool drive pulley (element #30) and flywheel (element #32), correctly assembled to said pillow block bearing, and rigidly assembled to said cogged pulley;
a rust protected, same keyway as long keyed shaft (element #28) tool drive pulley, for providing a means to transfer the output power generated by the philippians 419 engine to a tool of choice by the user, rigidly assembled to said long keyed shaft;
a rust protected, diameter equal to pulley, width designed for proper inertia desired during operation flywheel, for sustaining smooth and constant motion of the float chain sub-assembly (element #3) to the long keyed shaft (element #28), rigidly assembled to said long keyed shaft;
a rust protected, able to be securely clamped to the necklace (element #36) necklace clamp, for two purposes. the first purpose is to space the floats (element #38) apart from each other at a distance of its height only. the second is that this necklace clamp secures itself in a mechanical fashion by a clamp force greater than the expected torque value of the engine;
a rust protected, flexible, high tensile strength drive necklace, for providing a central, continuous loop of substantial strength, that floats (element # 38) and necklace clamp (element # 34) may be attached to in a continuous line from ene to end. it is this loop that collects and gathers all the power from individual floats and transmits that total power to the driven pulley (element #12), threadably clamped to said necklace clamp, and subassembly placed to said float chain sub-assembly;
a rust protected, self jamming necklace ends clamp, for allowing the assembler to connect securely the two ends of the drive necklace (element # 36). when the opposing set screws are properly torqued a self jamming situation is in place, firmly attached to said drive necklace;
a rust protected set screw, for securing the ends of the drive necklace (element #36) to each other while maintaining the same height as the regular necklace clamps (element #34), rigidly connected to said necklace ends clamp;
a rust protected, it will float, it is waterproof, design suited for lip seal sealing over most of the outside diameter, has center bore for receiving of drive necklace (element # 36), may be hollow yet waterproof, volume determined by anticipated power, number of determined by anticipated power float, for producing buoyancy lift and gravitational pull and then transmits those forces to the drive necklace (element #36) by first bumping into necklace clamp (element #34), threadably placed to said drive necklace;
a rust protected, weldment top mount, for securing the top of the liquid chamber (element #42 to the drive train sub-assembly (element #18), subassembly placed to said float chamber sub-assembly;
a rust protected, round tube, bottom face plate designed to accept the mounting of elements #52, 54, 56) liquid chamber, for providing the engine with an environment to flood liquid over the enclosed stationary floats. this chamber also houses the components (elements #50, 52, 54, and 56) that limits the flow of escaping liquid downward. this chamber will be capable of accepting a small amount of liquid through its top opening, rigidly assembled to said top mount;
a rust protected, centerhole slightly larger that float out side diameter, relief flow thru holes around its out side dia, securely mounted to the inside of the liquid chamber (element # 42), mounted at least 3 heights of the float (element #38) from the inside bottom plate surface flow plate, for directing the downward flow of the liquid that wants to flow out the bottom of the chamber when there is no floats sealed by either of the mounted lip seals (element #50). this element has flow holes about its outer diameter and the majority of escaping liquid uses this path and this path does not exert a down ward force upon the in-coming and soon to be rising floats (element #38.), rigidly attached to said liquid chamber;
a rust protected, welded construction lower mount, for to mount the liquid chamber (element # 42 securely to the lower post assembly (element # 24). another function of this mount is to provide a place to mount the exhaust ramp (element #48), rigidly assembled to said top mount;
a rust protected, center clearance hole for up-coming floats (element #38) exhaust ramp, for directing the exhaust flow of liquid away from the mechanics of the engine and to provide a mounting point for future installation of exhaust components;
a rust protected, uni-directional gland gland shaft seal, for sealing the float chamber (element #42) against substantial leaking of liquid when the incoming floats enter the liquid chamber. two of these elements are required so that the exhaust opening of the liquid chamber has always at least one float in place to eliminate gross exhaust flow;
a rust protected, two press in bore for radial lip seals (element #50, seal placement separation is 1½ times the height if a float (element #38), both seals mounted with pressure side up, through bore to be slightly larger that outside diameter of a float so as to limit exhaust flow of liquid seal mount, for the secure mounting of the two gland shaft seals (element #50). the spacing of the seals is critical and should be such that at least one float (element #38) is captured by at least one seal all the time of running, sealingly placed to said gland shaft seal, and rigidly assembled to said liquid chamber;
a water resistant exhaust sealing gasket, for forming a non-leak connection between the seal mount (element #52) and the bottom plate of the liquid chamber (element #42) and again between the liquid chamber (element #42) and the entrance tube (element #56), correctly captured to said seal mount;
a rust protected, tapered bore, minor bore to be slightly larger than float element #38) entrance tube, for to provide an alignment bore to secure the fact that the entering floats (element #38) will be positioned correctly when entering the gland shaft seals (element #50), rigidly connected to said exhaust sealing gasket; and
a water tight, service lid engine room, for to provide protection and security for the engine when the engine system is installed underground or under the top surface of a liquid. this unit could be used for safety and security of even an above ground installation. this engine room has ample room from within to house the appropriate tools and gear (examples: generator, alternator, switchgear, fuse box, regulators, ect.) the end user warrants from their needs. this element allows for a clear and non-environment disrupting installation. this unit provides protection against the natural elements and or vandels. this element allows for all external connections for both input and output requirements, rigidly mounted to said frame sub-assembly.
